(19) United States
(12) Patent Application Publication
(10) Pub. No.: US 2022/0411216 A1
(43) Pub. Date: Dec. 29, 2022

(54) SYSTEM FOR PREPARING A RADIOFREQUENCY IDENTIFICATION TAG AND ASSOCIATED METHOD

(71) Applicant: HID Textile Services SARL, La Ciotat (FR)

(72) Inventors: Brunel Jean-Victor, Gémenos (FR); Bastien Allaria-Bardy, Marseille (FR)

(21) Appl. No.: 17/756,471

(22) PCT Filed: Nov. 19, 2020
(86) PCT No.: PCT/EP2020/082741

§ 371 Date: May 25, 2022

(30) Foreign Application Priority Data
Nov. 26, 2019 (FR) 1913203

(51) Int. Cl. B65H 16/00; G06K 19/077

(52) U.S. Cl. CPC B65H 16/005; G06K 19/07718; B65H 2701/1244; B65H 2701/174

(57) ABSTRACT

The invention relates to a system for preparing a radiofrequency identification tag for attachment to a support, the system comprising a placement device configured to place the tag on the support, the placement device comprising a displacement member that is movable between a loading position and a placement position, and a holding member having a configuration for releasing the tag and a configuration for holding the tag, the holding member being in the configuration for holding the tag during a movement of the displacement member between the loading position and the placement position. The system makes it possible to automate the placement of the tag for its attachment to the support, for example a textile.

### TECHNICAL FIELD

The present invention relates to the field of systems for preparing a radiofrequency identification tag. It finds a particularly advantageous application in automating the integration of radiofrequency identification tags on a support, and in particular textiles.

### STATE OF THE ART

Radiofrequency identification tags, also known as RFID tags, can be used to identify, track, and even analyze the use of the support on which they are attached.

In particular, hospitals or hotels often use RFID tags to identify and track linens, such as bed sheets, pillowcases and towels, during use and then for cleaning in the laundry.

In this context, RFID tags are designed and attached to laundry to sustainably withstand almost continuous use as well as intensive cleaning of laundry in harsh washing processes, particularly in terms of pressure, temperature, and chemical products used.

There are RFID tag preparation methods. According to a first example, document FR 3012682 (A1) describes a method for manufacturing an RFID tag for linens that must withstand industrial laundry cycles. According to a second example. According to a second example, document WO 2017/195970 (A1) describes a method for manufacturing an RFID tag that can be placed on a fabric.

At the end of this production, the RFID tags are generally placed and attached on the fabrics manually, by operators. These operations can be done either during the manufacture of the linens or by the owner of the linens, for example in hospitals or hotels. However, manual placement, or even manual attachment, of the RFID tag has the disadvantage of being long and expensive. The result also depends on the qualification of the operator in charge of this operation. Errors may therefore occur, which may further increase the cost of the RFID tag preparation methods.

Document EP 2340513 A2 discloses a system for transferring RFID tags to an object, in which the tags are supported by a continuous strip.

Document US 2009/126861 A1 discloses a system for forming RFID tags on packaging, comprising a system for unwinding a support strip and a peeling member in combination with a pressing member.

An objective of the present invention is therefore to propose a system facilitating the automation of the preparation of an RFID tag, and more particularly with a view to its attachment to a support.

The other objects, features and advantages of the present invention will become apparent from a review of the following description and the accompanying drawings. It is understood that other benefits may be incorporated.

### SUMMARY

To achieve this objective, according to a first aspect of the invention there is provided a system for preparing a radiofrequency identification tag with a view to attachment to a support, characterized in that it comprises a placement device for placing at least one radiofrequency identification tag, configured so as to place the tag on the support, the placement device comprising:
a displacement member that is movable between a loading position and a placement position, the placement position being separate from the loading position, and
a holding member having a configuration for releasing the tag, and a configuration for holding the tag, the holding member being in the configuration for holding the tag during a movement of the displacement member between the loading position and the placement position.

Thus, the system allows the tag to be positioned on the support via the movement of the displacement member, while ensuring the holding of the tag. Therefore, the system makes it possible to go further in automating tag preparation than the existing solutions. More particularly, the system allows automation of the placement of the tag with a view to its attachment to the support, for example a textile.

Advantageously, the system can be used in a standard method for manufacturing the support. The system can for example additionally be mounted on a production line of the support. The system can alternatively or additionally be used to tag the support after manufacture thereof, and in particular by the owner of the support.

According to a second aspect of the invention, separable from or complementary to the first aspect, there is provided a system for preparing a radiofrequency identification tag with a view to attachment to a support, characterized in that in that the system comprises a device for supplying at least one radiofrequency identification tag, the supply device comprising:
a drive member configured to drive a strip of tags in a first driving direction,
a member for orienting the strip of tags, comprising a bevel gear arranged along an axis not perpendicular to the first driving direction, so as to orient the strip of tags according to a second driving direction distinct from the first driving direction.

From the reel, a strip of tags can thus be unwound and oriented in an automated manner toward another device in the system, or even toward another system. Therefore, the system makes it possible to go further in automating tag preparation than the existing solutions. In particular, the system allows automation, following the manufacture of the tag, of the preparation of the radiofrequency identification tag with a view to attachment to the support, such as a textile.

The system may further comprise a placement device, and more particularly a holding member, having a configuration for releasing the tag, and a configuration for holding the tag, the orientation member being configured to cooperate with the placement device so as to supply it with the tag. Preferably, the first driving direction and the second driving direction are orthogonal. The placement device may further comprise the displacement member according to the features set out above.

According to a third aspect of the invention, there is provided a method for preparing a radiofrequency identification tag with a view to attachment to a support, via a radiofrequency identification tag preparation system according to the first aspect of the invention, the method comprising:
supplying at least one radiofrequency identification tag to a placement device, the placement device comprising a displacement member in a loading position and a holding member in a tag release configuration, then
taking the holding member from the release configuration to a tag holding configuration, then
moving the displacement member from the loading position to a placement position, the placement position being distinct from the loading position, so as to position the tag on the support.

### BRIEF DESCRIPTION OF FIGURES

The aims, objects, as well as the features and advantages of the invention will emerge better from the detailed description of an embodiment of the latter that is illustrated by the following accompanying drawings, in which:

FIGS. 1A and 1B show an overview of the system in the loading position and in the tag release configuration, according to one embodiment of the invention.

FIG. 2 shows an overall view of the system, in the placement position and in the tag holding configuration, according to the embodiment illustrated in FIGS. 1A and 1B.

FIG. 3 shows a detailed view of part of the placement device of the system illustrated in FIGS. 1A and 1B.

FIG. 4 shows a detailed view of part of the placement device, and in the tag ejection configuration, of the system illustrated in FIGS. 1A and 1B.

The drawings are given by way of examples and do not limit the invention. They constitute schematic illustrations intended to facilitate understanding of the invention and are not necessarily at the scale of practical applications. In particular, the dimensions and the relative distances between the elements of the system are not necessarily representative of reality.

### DETAILED DESCRIPTION

Before undertaking a detailed review of embodiments of the different aspects of the invention, optional features of the first and second aspects of the invention are set out below, which may optionally be used in combination or alternatively:
the displacement member may comprise at least one actuator secured to the holding member, the linear actuator being at least partly translatable between the loading position and the placement position, so as to move the holding member between the loading position and the placement position. The linear actuator thus positions the tag in a reproducible and precise manner on the support, and more particularly with a view to attaching it on the support. Preferably, the linear actuator is a cylinder,
the holding member may comprise a jaw extending transversely along a tag loading direction, the jaw comprising a first member and a second member spaced apart by a first distance perpendicular to the loading direction when the holding member is in the release configuration such that the tag fits into the jaw with the first member and the second member spaced apart by a second distance perpendicular to the loading direction when the holding member is in the holding configuration, so as to hold the tag, the first distance being greater than the second distance,
the first member and the second member of the jaw can each be configured such that at least one of the first member and the second member has a degree of freedom in flexion with respect to the other member, over at least one angular interval,
at least one of the length and the width of the first member and of the second member may be less than at least one of the corresponding length and width of the tag,
the holding member may comprise at least one linear actuator whereof a first portion, or even a first end, is translatable so as to bear against at least one of the first member and the second member, when the holding member is in the holding configuration,
the holding member may further comprise a sliding plate that is translatable relative to the jaw in a direction parallel to the translation movement between the loading position and the placement position, the displacement member comprising a linear actuator secured to at least a part of the jaw, and a linear actuator secured to the sliding plate,
the holding member may comprise a jaw extending transversely along a tag loading direction; the second driving direction is parallel, and preferably coincident, with the tag loading direction. By cooperation between the supply device and the placement device, the system makes it possible to further facilitate the automation of the preparation of the tag, with a view to attaching it on the support,
the supply device may further comprise a module for detecting an interstitial zone between two successive tags of the strip of tags,
wherein the supply device may further comprise a member for cutting the strip of tags, configured to cooperate with the detection module so as to cut the strip of tags at the interstitial zone,
the cutting member can be arranged between the detection module and the holding member, and configured to actuate when the holding member is in the tag holding configuration,
the drive member may comprise a motor controlled to drive the strip of tags at a first speed and at a second speed, the first speed being greater than the second speed, such that after moving the tag over a distance, said distance preferably being less than a length of a tag, the strip of tags is driven at the second speed until the interstitial zone is detected,
the supply device may further comprise a verification module configured to detect a defect of the tag, the placement device being configured to eject the tag from the system when the defect is detected by the verification module. The verification module is preferably configured to detect a mark characteristic of a tag defect.

In the remainder of the description, use will be made of terms such as “vertical,” “horizontal,” “longitudinal,” “transverse,” “upper,” “lower.” These terms should be interpreted relatively with regard to the position of the tag preparation system in the coordinate system illustrated in the figures. For example, “higher” and “lower” mean relative to the z axis, an element higher than another element being arranged in a plane located above the plane of this other element relative to the z axis.

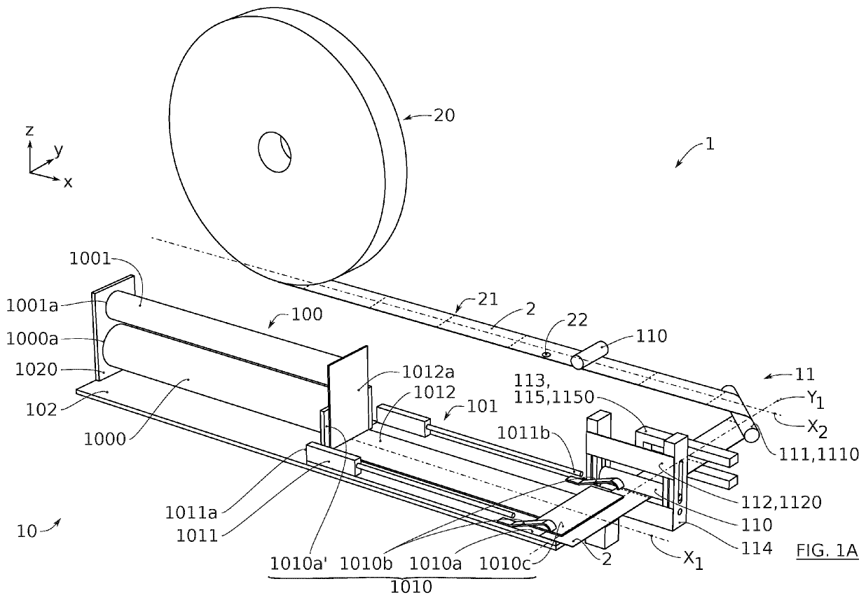

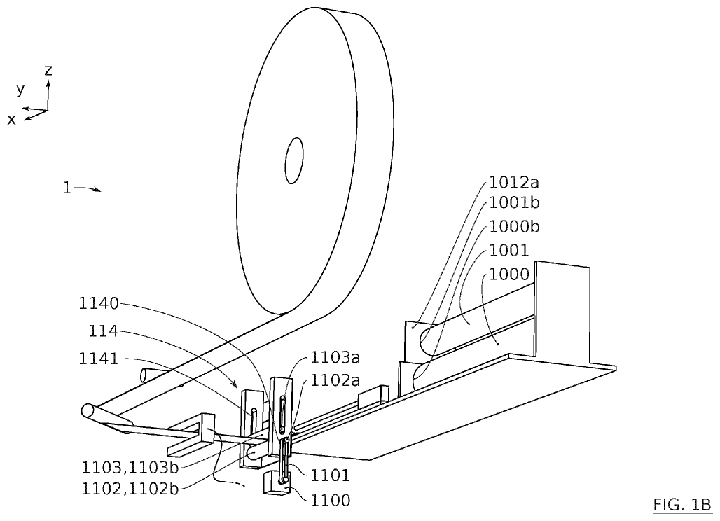

The RFID tag preparation system 1 according to a particular embodiment is now described with reference to FIGS. 1A to 4.

The system 1 is configured in such a way as to allow the placement of an RFID tag 2 on a support 3. The support 3 can more particularly be a textile, such as a bed linen or a bathroom linen. During or after the placement of the tag 2, this tag 2 can be attached to the support 3, for example by sewing or heat-sealing. Thus, the support 3 can be identified or even tracked by radio-identification.

The system 1 can therefore comprise a device 11 for supplying the tag and/or a device 10 for placing the tag 2. When the system 1 comprises the tag supply device 11 and the placement device 10, these two devices can cooperate with each other so that the supply device 11 supplies the tag 2 to the placement device 10, the latter then being able to place the tag 2 on the support 3.

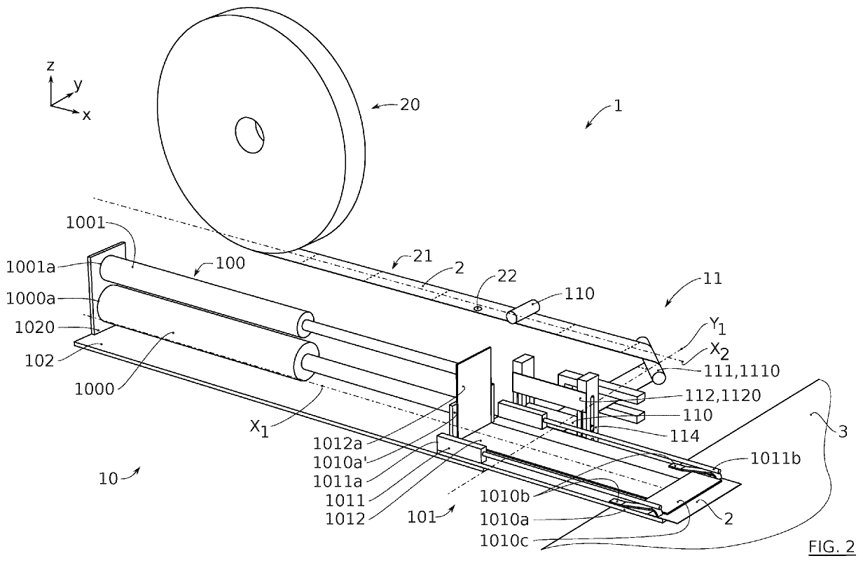

The tag placement device 10 is first described in detail according to one embodiment of the system 1 and allows the release and placement of the tag 2 on the support 3 according to one embodiment of the tag preparation method. The placement device 10 for placing the tag 2 comprises a displacement member 100 and a holding member 101 for the tag. This displacement member 100 is movable between a loading position and a placement position of the tag 2. In the loading position, the displacement member 100 is more particularly configured so that the tag can be loaded into the holding member 101, as illustrated for example in FIG. 1A. The placement position, which is distinct from the loading position, corresponds to a position in which the tag can be placed on the support 3, as illustrated in FIG. 2. The displacement member 100 is secured to the holding member 101, and thus moves the holding member 101 between the loading position and the placement position.

The holding member 101 has a tag 2 release configuration, in which the tag 2 is not held by the holding member 101, and a tag 2 holding configuration, in which the tag 2 is held by the holding member 101.

The action kinematics of the placement device 10 can be described as follows. A tag 2 can first be supplied to the placement device 10 when the displacement member 100 is in the loading position, and when the holding member 101 is in the release position. The holding member 101 can then be taken to its tag 2 holding configuration. The displacement member 100 can then move the holding member 101 from the loading position to the placement position. The holding member 101 can then be taken to its release position, so as to leave the tag 2 in the desired location of the support 3. The displacement member 100 can return the holding member 101 to the loading position. The next tag 2 can then be handled by the system 1.

According to the example illustrated by FIGS. 1A and 2, the displacement member 100 can be translatable between the loading position and the placement position, in the direction x₁. To this end, the displacement member 100 can comprise a linear actuator 1000, for example a cylinder. The loading position is preferably a retracted position of the linear actuator 1000, and the placement position is preferably an extended position of the linear actuator 1000. This actuator can be mounted by a first portion, and preferably by a first end 1000a, to a frame 102 of the placement device 10, and more particularly a wall 1020 of the frame 120, the frame 102 remaining stationary during the movement of the displacement member 100. The linear actuator 1000 can be mounted by a second portion, and preferably by a second end 1000b, to at least part of holding member 101.

To hold the tag 2, the holding member 101 may comprise a jaw 1010. This jaw 1010 can extend transversely along a loading direction y₁ of the tag in the placement device 10. The loading direction y₁ is preferably distinct from the translational movement direction x₁ of the displacement member, and preferably orthogonal, or even perpendicular, to this direction x₁.

Furthermore, the jaw 1010 can comprise a first member 1010a, preferably a lower member, and a second member 1010b, preferably an upper member, between which the tag 2 can be inserted when the holding member 100 is in the release configuration. By way of illustration, the following describes the particular embodiment in which the jaw comprises a lower member 1010a and an upper member 1010b. Preferably, the jaw 1010 is configured so as to hold the tag 2 by its thickness when the holding member 101 is in the holding configuration.

To this end, the lower member 1010a and the upper member 1010b can be spaced apart vertically by a first distance, that is to say, along the z axis perpendicular to the loading direction y₁. The first distance is then greater than the thickness of the tag 2, so as to allow the passage of the tag 2 between the members 1010a, 1010b of the jaw 1010. In the holding configuration, the lower member 1010a and the upper member 1010b can be spaced apart vertically by a second distance of less than the thickness of the tag 2, so as to block the tag 2 between the members 1010a, 1010b of the jaw 1010.

To move the members 1010a, 1010b away from or closer to the jaw 1010, the members 1010a, 1010b are configured such that at least one of the lower member 1010a and the upper member 1010b has a degree of freedom in flexion with respect to the other member, over at least one angular interval. Thus, the holding member 101 is configured similarly to a clamp that can release or hold the tag 2 depending on the distance between these two members 1010a, 1010b. Through a flexural movement, the first member 1010a and the second member 1010b of the jaw can be brought together until they come into contact with the tag 2. The system 1 is thus suitable for the automated preparation of RFID tags of different thicknesses. At least one of the lower member 1010a and the upper member 1010b can in particular be constrained in flexion by the support of at least one linear actuator 1011. Preferably, the at least one flexibly deformable member is formed from an elastically deformable material, for example metal. Thus, when the linear actuator 1011 is not resting on the member, the holding member passes from the holding configuration to the release configuration by elastic return of the deformable member in flexion to its unconstrained position.

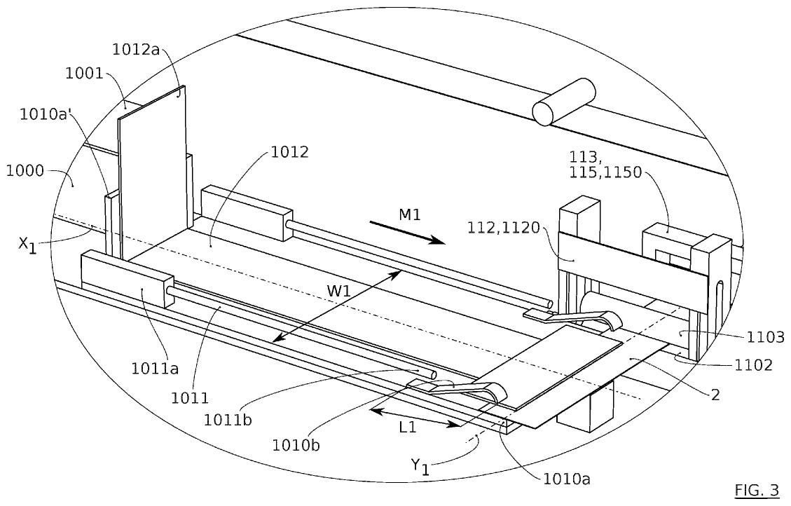

According to the example illustrated in FIG. 3, a first cylinder 1000 is secured to the lower member 1010a of the jaw 1010, and more particularly by the wall 1010a′ of the lower member 1010a. The lower member 1010a is more particularly formed by a plate extending over a width W1 in the direction y₁. The upper member 1010b is formed by a pair of tabs 1010b, attached to the lower member 1010a, and extending along the direction x over a length L1.

According to this example, a pair of needle cylinders 1011 have a body by which they are mounted by a first end 1011a on the lower member 1010a. The second end 1011b of each needle cylinder 1011 is the end of a cylinder rod, arranged so as not to constrain the upper member 1010b in flexion when the holding member 101 is in the release configuration. When the holding member 101 is in the holding configuration, each needle cylinder 1011 can be deployed in translation in the direction x₁, as illustrated by the arrow M1, so as to bring their second end 1011b to bear on the pair of tabs 1010b, to constrain them in flexion, and thus to bring the two members 1010a, 1010b closer together.

The jaw 1010 can further comprise a loading guide 1010c extending along the direction y₁ between the two tabs 1010b, to ensure sliding of the tag 2 along the loading direction y₁, from one tab to the other.

In addition, the dimensions of the holding member 101 can be chosen so that at least one edge of the tag 2 is free, in particular when the holding member 101 is in its holding configuration. Thus, the attachment of the tag 2 by its edge that has remained free is facilitated. According to the example illustrated in FIG. 3, the width W1 of the lower member 1010a can be less than the length of the tag. Alternatively or additionally, the jaw 1010 can be configured so that the width of the portion of the tag 2 that is intended to be inserted between the lower member 1010a and the upper member 1010b is less than the total width of the tag 2.

The dimensions of the holding member 101 can also be chosen to facilitate its insertion between two supports 3, and in particular between two fabrics. The thickness of the holding member is for example 6.5 mm.

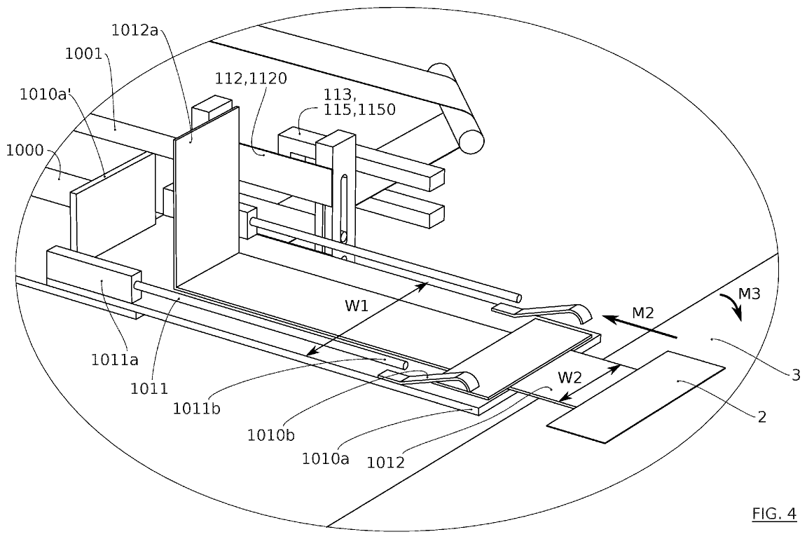

The holding member 101 may further comprise a sliding plate 1012, configured to be movable relative to the jaw 1010, and more particularly relative to at least one of the lower member 1010a and the upper member 1010b. The sliding plate 1012 can in particular be translatable relative to the jaw 1010, in the direction x₁. When the jaw 1010 is moved in translation from the placement position to the loading position, in the direction indicated by the arrow M2 illustrated for example by FIG. 4, the holding member 101 being in the release configuration, the sliding plate 1012 can remain stationary at least over a portion of the movement from the placement position to the loading position. Thus, the sliding plate 1012 can be positioned beyond the position of the jaw 1010. This advance of the sliding plate 1012 can promote the tilting of the tag 2, for example as illustrated by the arrow M3, and facilitate the release and therefore the deposition of the tag 2. The risk of the tag being driven during the withdrawal of the displacement member 100 is minimized, or even avoided.

In addition, the loading guide 1010c can guide the translational movement of the sliding plate 1012 and thus limit, or even prevent, a movement of the latter in the direction z during the deposition of the tag. Furthermore, if the tag is attached to the support when the displacement member is in the placement position, the risk of tearing off the tag when the displacement member 100 is withdrawn is minimized or even avoided.

According to the example illustrated in FIG. 4, the sliding plate 1012 extends over a width W2 in the direction y₁, its width W2 being less than the width W1 of the lower member 1010a. The sliding plate 1012 can be arranged between the two needle cylinders 1011 as well as between the tabs of the upper member 1010b. The sliding plate can also be arranged between the lower member 1010a and the sliding guide 1010c. The tag 2 can therefore be inserted between the lower member 1010a and the sliding guide 1010c, so that the sliding plate 1012 applies a pushing force to the tag 2 along its edge.

To drive the sliding plate 1012 in translation in the direction x₁, the displacement member 100 can comprise a second linear actuator 1001, for example a cylinder. This actuator can be mounted by a first portion, and preferably by a first end 1001a, to the frame 102. The linear actuator 1001 can be mounted by a second portion, and preferably by a second end 1001b, to the sliding plate 1012, and more particularly to its wall 1012a, as illustrated in FIG. 1B.

More particularly, the action kinematics of the first linear actuator 1000 and of the second linear actuator 1001 can be as follows. The first linear actuator 1000, which is connected to the jaw 1010, can be actuated by driving the second actuator 1001, which is for example an ejector cylinder then free of pressure. Once the holding member has entered the release configuration and the tag 2 has been placed, the second actuator 1001 is actuated, for example pressurized, and the first linear actuator 1000 withdraws, so as to cause a shift in position between the sliding plate 1012 and the jaw 1010. When the first linear actuator 1000 reaches a certain stroke position between the placement position and the loading position, for example when it is detected at a sensor, the second actuator 1001 can be deactivated; for example, the pressure in this actuator drops. The first actuator 1000 can then bring the second actuator 1001 back to the loading position.

According to the example illustrated in FIGS. 1A, 1B and 2, in order to avoid a misalignment of the placement device 10 during the movement of the linear actuators 1000, 1001, these actuators can be superposed on one another along the z axis, being attached by their first end 1000a, 1001a to a vertical wall 1020 of the frame 1012. The first actuator 1000 and the second actuator 1001 can be attached by a vertical wall 1010a′, 1012a to the lower member 1010a of the jaw 1010 and to the sliding plate 1012, respectively.

The supply device 11 of the tag 2, which is separable from the placement device, is now described in detail according to one embodiment of the system 1 and allows the supply of the tag 2, even its preparation upstream of its supply, according to one embodiment of the tag preparation method. The device 11 for supplying the tag 2 first comprises a drive member 110 configured to drive the tag 2 along a first driving direction x₂. The tag can more particularly take the form of a strip 20 comprising a plurality of tags 2 wound up in the form of a reel. The drive member 110 can be configured to unwind the strip 20 by driving it along the first driving direction x₂.

The supply device 11 further comprises a member 111 for orienting the strip 20, configured to orient the strip 20 along a second driving direction y₁ distinct from the first driving direction x₂. To this end, the orientation member 111 comprises a bevel gear 1110 disposed along an axis that is not perpendicular to the first driving direction x₂. According to the example illustrated by FIG. 1A, the bevel gear 1110 can be a cylinder arranged substantially at 45° from the first driving direction x₂, the strip sliding over part of the circumference of the cylinder, to be oriented in the second direction y₁, orthogonal to the first direction x₂.

The orientation member 111 can more particularly be configured to cooperate with the placement device 10, so that the tag is automatically supplied to the placement device 10. Preferably, the second driving direction y₁ coincides with the loading direction y₁ of the tag in the holding member 101. Since the loading direction y₁ can be orthogonal to both the first driving direction x₂ and to the translational movement of the placement device in the direction x₁, the supply device 11 and the placement device 10 can thus be configured to increase the compactness of the system 1. Consequently, the handling of the system 1 by an operator, or even its installation on a standard production line for the support 3, is facilitated. For example, the width of the system 1 is approximately 150 mm.

In the example illustrated by FIGS. 1A, 1B and 2, the bevel gear 1110 is configured to orient the strip 20 to the right, with respect to the strip 20 wound in reel form. Note that the supply device 11 can be designed to be mounted independently to orient the strip 20 to the left or to the right, so as to adapt to the available space.

To drive the strip 20 in the first driving direction x₂, then in the second driving direction y₁ after the bevel gear 1110, the drive member 110 may comprise a plurality of rollers, intended to be in contact with the strip 20 and rotatable around a direction perpendicular to the driving direction of the strip 20. At least one roller can be rotated by a motor 1100, for example by a belt 1101 as illustrated in FIG. 1B. Preferably, the motor 1100 is a stepping electric motor. The at least one roller is further configured to in turn drive a translational movement of the strip 20 in at least one driving direction. This roller can be arranged either before or after the bevel gear 1110, to drive the strip 20 either in the first driving direction x₂ or in the second driving direction y₁, and to cause the progression of the strip 20 in the system 1 as a whole. Other rollers can be added along the journey of the strip 20 to guide it.

According to a particular embodiment, the drive member comprises a pair of rollers, with a lower roller 1102 that is rotated via its end 1102a by the motor 1100, and an upper roller 1103, each roller being in contact with one face of the strip 20. Thus, the transmission of the movement from the roller 1102 to the strip 20 is facilitated. At least one roller, and preferably the lower roller 1102, may have a rough surface 1102b, for example a grip or a rough silicone coating, to further promote this transmission of movement. In addition, this pair of rollers can ensure alignment of the strip 20 with the holding member 101, more particularly to ensure the insertion of the strip 20 into the jaw 1010. To this end, this pair of rollers can be arranged close to the holding member 101, and in particular the jaw 1010, along the driving direction y₁.

The lower roller 1102 can also be configured to be stationary relative to the system 1, while the upper roller 1103 can have relative translational mobility relative to the lower roller 1102, in a vertical direction, so as to be in contact with an upper face of the strip 20, including when the thickness of the tag 2 varies. Thus, the system 1 can accommodate tags 20 of different thicknesses. The variations in thickness that can be accommodated are typically of the order of 1.5 to 2 mm. Note that alternatively, provision can be made for the relative positions of these two rollers to be reversed.

To allow the relative mobility of the upper roller 1103, the supply device 11 can comprise a thickness adaptation member 114, on which at least the upper roller 1103 is mounted. The lower roller can also be mounted stationary on the thickness adaptation member 114. According to the example illustrated in FIG. 1B, the adaptation member can be formed by two profiles each having a hole 1140 in which each end 1102a of the lower roller 1102 is inserted. Each profile may have a groove 1141 that extends vertically, and in which each end 1103a of the upper roller 1103 is inserted. The thickness adaptation member 114 can further comprise a spring inserted in each profile, each spring being supported by a first portion, or even a first end, on each end 1103a of the upper roller 1103, so as to keep the surface 1103b of the upper roller 1103 in contact with the upper face of the strip 20. It can also be envisaged for a second portion, or even a second end of each spring, to be connected to an element for adjusting the stiffness of the spring.

The supply device 11 can be configured to separate each tag 2 from the strip 20. To this end, the supply device 11 may comprise a cutting member 112. Preferably, the cutting member is arranged between the drive member 110 and the holding member 101, so that the drive member 110 inserts a tag 2 of the strip 20 into the holding member 101, and so that the cutting member 112 cuts the strip 20 in order to separate this tag 2. The cutting member 112 is preferably actuated when the holding member 101 is in the tag 2 holding configuration. Cutting is thus performed more reliably by the system 1. In particular, the risk of the tag shifting during cutting is minimized, or even avoided, which limits the risk of damaging the RFID circuit of the tag.

The cutting is preferably mechanical, which saves on costs and facilitates the maintenance of the cutting member. According to the example illustrated in FIG. 1A, the cutting member 112 is formed by a guillotine 1120 that can move vertically in translation. Alternatively, it is possible to provide that the cutting member is formed by a scissor-type actuator. Alternatively, the cutting can be non-mechanical, for example by ultrasound or by laser.

A detection module 115 can cooperate with the cutting member 112 to coordinate its actuation. From a strip 20, the system 1 thus allows the separation of each tag 2 in an automated manner, for example for the supply thereof to the holding member 101. More particularly, the detection module 115 can detect an interstitial zone 21 between two successive tags 2 of the strip 20. This interstitial zone 21 can in particular be an optical mark, such as a print line or a change in appearance of the fabric of the strip, for example following cauterization of the fabric. To detect it, the detection module 115 can comprise an optical sensor 1150, preferably arranged along the second driving direction y₁.

After a rapid advance corresponding to a fraction, for example configurable, of the length of the tag 2, the motor 1100 can reduce the driving speed of the strip 20 until the detection module 115 detects the interstitial zone 21. The strip 20 can then be driven by a fixed pitch corresponding to the distance between the detection module 115 and the cutting member 112. The risk of a bad cut is minimized or even avoided. Preferably, the detection module 115 is preferentially placed after the drive member 110 in order to minimize the distance between the detection module 115 and the cutting member 112.

Furthermore, the supply device 11 may comprise a verification module 113, configured to detect a mark 22 that is characteristic of a defect in the tag 2 and to cooperate with the placement device 10 so as not to place the tag 2 on the support 3. The verification module 113 makes it possible to avoid placing, or even attaching, a defective tag 2 on the support. Tag preparation efficiency can therefore be maximized.

The mark 22 can in particular be an optical mark, such as a printing mark or an alteration of the tag 2, such as a hole drilled in the tag. According to one example, this mark is affixed to the tag 2 during a verification of the state of the RFID tag upstream of the winding of the strip 20. To detect this mark, the verification module 113 can use the optical sensor 1150 of the detection module 115, which avoids the addition of an additional sensor to the system 1.

Following the detection of this mark, the placement device 10 can eject the tag 2. The detection, or even the ejection, of a defective tag can be comprised in the tag preparation method. When the displacement member 100 is in the loading position, the holding member 101 being in the release configuration, the jaw 1010 can be translated from the loading position to an ejection position, in the direction x₁, the ejection position being farther from the placement position than the loading position. The sliding plate 1012 can also remain stationary. Thus, the sliding plate 1012 can be offset from the position of the jaw 1010. This offset of the sliding plate 1012 can promote the tilting of the tag 2, for example in a scrap collection bin placed below.

In order to control all the actions of the system 1, the system 1 can comprise a control module, not illustrated in the figures. Provision can also be made for certain modules or members of the system to be manually operable, such as the cutting member 112, for example. The control module can further comprise a touchscreen, allowing the setting of the system 1, or even manual tests.

The method for preparing a radiofrequency identification tag 2 for attachment to a support 3 is now described according to one embodiment. The method uses the system 1 according to the features stated above.

The method comprises supplying at least one radiofrequency identification tag 2 to the placement device 10, and more particularly to the holding member. Through the movement of the displacement member 100 from the loading position to the placement position, the tag 2 is positioned on the support 3.

The tag 2 can be supplied by the supply device 10. The tag 2 can be supplied in the form of the strip 20 of tags 2, for example rolled up in the form of a reel. Prior to supplying the tag, the method may comprise a step of treating the strip 20 so as to mark the interstitial zone 21 between at least two successive tags, and preferably between each tag 2. This treatment may comprise ultrasound cauterization of the fabric of the tag 2 at the interstitial zone 21. Cauterization advantageously allows fraying of the fabric of the tag 2 to be avoided during cutting thereof.

It should be noted that the method can comprise additional steps corresponding to the actions of the system 1 described above.

The invention is not limited to the embodiments previously described and extends to all embodiments covered by the claims.

The examples given describe packaging of the tags 2 in strips 20, in which the tags 2 are secured by their width. It is possible to provide packaging in which the tags 2 are secured by their length, and an adaptation of the dimensions of the system 1 to accommodate this packaging.

### LIST OF REFERENCES

1 System
10 Placement device
100 Displacement member
1000 First linear actuator
1000a First end
1000b Second end
1001 Second linear actuator
1001a First end
1001b Second end
101 Holding member
1010 Jaw
1010a Lower member
1010a′ Wall
1010b Upper member
1010c Loading guide
1011 Linear actuator
1011a First end
1011b Second end
1012 Sliding plate
1012a Wall
102 Frame
1020 Wall
11 Supply device
110 Drive member
1100 Motor
1101 Belt
1102 Lower roller
1102a End
1102b Surface
1103 Upper roller
1103a End
1103b Surface
111 Orientation member
1110 Bevel gear
112 Cutting member
1120 Guillotine
113 Verification module
114 Thickness adaptation member
1140 Hole
1141 Groove
115 Detection module
1150 Optical sensor
2 RFID tag
20 Strip of tags
21 Interstitial zone
22 Mark characteristic of a defect
3 Support
W1 lower member width
W2 sliding plate width
L1 upper member length

1. A system for preparing a radiofrequency identification tag for attachment to a support, the system comprising a placement device configured to place the tag on the support, the placement device comprising:
a displacement member that is movable between a loading position and a placement position, the placement position being separate from the loading position; and
a holding member having a configuration for releasing the tag and a configuration for holding the tag, the holding member being in the configuration for holding the tag during a movement of the displacement member between the loading position and the placement position.

2. The system of claim 1, wherein the displacement member comprises at least one linear actuator secured to the holding member being at least partly translatable between the loading position and the placement position, so as to move the holding member between the loading position and the placement position.

3. The system of claim 1, wherein the holding member comprises a jaw extending along a tag loading direction, the jaw comprising a first member and a second member spaced apart by a first distance perpendicular to the tag loading direction when the holding member is in the configuration for releasing the tag such that the tag fits into the jaw and spaced apart by a second distance perpendicular to the tag loading direction when the holding member is in the configuration for holding the tag, so as to hold the tag, the first distance being greater than the second distance.

4. The system of claim 3, wherein the first member and the second member of the jaw are configured such that at least one of the first member and the second member has a degree of freedom in flexion with respect to the other member, over at least one angular interval.

5. The system of claim 3, wherein at least one of a length and a width of the first member is less than at least one of a corresponding length and width of the tag.

6. The system of claim 4, wherein the holding member comprises at least one linear actuator whereof a first portion is translatable so as to bear against at least one of the first member and the second member when the holding member is in the configuration for holding the tag.

7. The system of claim 3, the holding member further comprising a sliding plate that is translatable relative to the jaw, in a direction parallel to an axis of movement of the displacement member between the loading position and the placement position, the displacement member comprising a linear actuator secured to at least a part of the jaw and a linear actuator secured to the sliding plate.

8. The system of claim 1, further comprising a supply device comprising:
a drive member configured to drive a strip of tags in a first driving direction;
an orientation member for the strip of tags, the orientation member comprising a bevel gear arranged along an axis that is not perpendicular to the first driving direction, so as to orient the strip of tags along a second driving direction that is different from the first driving direction, and to supply the tag to the holding member.

9. The system of claim 8, wherein, the holding member comprises a jaw extending along a loading direction of the tag, wherein the second driving direction is parallel with the loading direction of the tag.

10. The system of claim 8, wherein the supply device further comprises a detection module for detecting an interstitial zone between two successive tags of the strip of tags.

11. The system of claim 10, wherein the supply device further comprises a cutting member for cutting the strip of tags and configured to cooperate with the detection module so as to cut the strip of tags at the interstitial zone.

12. The system of claim 11, wherein the cutting member is arranged between the detection module and the holding member, and is configured to actuate when the holding member is in the configuration for holding the tag.

13. The system of claim 10, wherein the drive member comprises a motor controlled to drive the strip of tags at a first speed and at a second speed, the first speed being greater than the second speed, such that after moving the tag over a distance, said distance being less than a length of the tag, the strip of tags is driven at the second speed until the interstitial zone is detected.

14. The system of claim 8, wherein the supply device further comprises a verification module configured to detect a defect of the tag, and the placement device is configured to eject the tag from the system when the defect is detected by the verification module.

15. A method for preparing a radiofrequency identification tag for attachment to a support, the method comprising:
supplying the tag to a placement device, the placement device comprising a displacement member in a loading position and a holding member in a tag release configuration;
moving the holding member from the release configuration to a tag holding configuration; and
moving the displacement member from the loading position to a placement position, the placement position being distinct from the loading position, so as to position the tag on the support.

16. The system of claim 3, wherein at least one of a length and a width of the second member is less than at least one of a corresponding length and width of the tag.

17. The system of claim 9, wherein the second driving direction is coincident with the loading direction of the tag.
